(19) United States
(12) Patent Application Publication
(10) Pub. No.: US 2009/0023429 A1
(43) Pub. Date: Jan. 22, 2009

(54) Asynchronous search platform for mobile device users

(75) Inventors: Mor Naaman, San Francisco, CA (US); Vlad Kaplun, Berkeley, CA (US); Shane Ahern, Foster City, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/879,599

(22) Filed: Jul. 17, 2007

(51) Int. Cl. H04L 29/06

(52) U.S. Cl. 455/414.3

(57) ABSTRACT

Apparatus for an asynchronous search platform is provided in which a user may submit a request for information via a mobile device and receives a response from a researcher. In one example, the apparatus includes a server operable to receive a user-generated request from a mobile device, communicate the request to a researcher (i.e., a person) for formulating a response to the request, and communicate the response to the mobile device. Each received request is sent to a researcher that attempts to generate a response to the request for sending to the user's mobile device. The researcher may further access user information for generating the response. The process operates asynchronously where, for example, a user's request is queued until an actual person, i.e., a researcher, is available to serve the request by obtaining the information requested. The quality and relevancy of information obtained may be improved over automated systems that rely solely on computers to serve such requests.

### BACKGROUND

1. Field

The present invention relates generally to systems and methods for receiving and responding to user-generated requests via a computing device, such as a mobile computing device, and in one example, to a method and system in which user-generated requests from mobile devices are communicated to researches for asynchronously responding to the requests.

2. Related Art

Users of mobile devices, such as cellular phones and personal digital assistants (PDAs), typically do not have access to the quality of information they desire. For example, when a user of a mobile device is driving an automobile, the user may desire the locations of nearby gasoline stations and the current price of gasoline sold at each station. In such instances, however, the user may not have the ability or time to search for and access such information from the mobile device. A user may therefore forgo obtaining desired information because the user does not have the time or capacity via the mobile phone to access desired information sources.

Additionally, mobile devices are typically less capable (e.g., in terms of processing speed, memory, display capabilities, connectivity, etc.) and more difficult to navigate than stand alone computers, such as personal computers, to access sources capable of servicing many requests in a reasonable amount of time. Accordingly, additional methods and systems for obtaining information by users of mobile devices are desired.

Further, from a research perspective, conducting studies that require user experience reporting, it is difficult to capture all significant experiences because there is little motivation for users to actually record and submit their experiences. Methods that provide useful feedback or rewards, such as experience relevant content delivery, are useful in lowering the threshold for users to record and submit their experiences.

### BRIEF SUMMARY

According to one aspect of the present invention a system and method are provided for facilitating asynchronous searching between a user and a researcher. In one example, the apparatus includes logic for receiving a user-generated request from a mobile device, and logic for causing communication of at least a portion of the request to a researcher (e.g., a person other than the user) for generating a response to the request. The requests may be routed and queued (locally or remotely) for a researcher to access the request and formulate a response. The apparatus further includes logic for causing communication of the response to the mobile device (e.g., the desired information or a link to the desired information).

The request may comprise any suitable form of communication such as a text message, web entry, voice mail, audio file, or the like. The response communicated to the mobile device may also include any suitable form of communication such as a text message, a link to a webpage or media object, or a media object. In one example, the response is communicated in the same form as the request was communicated.

The request may be communicated to a remote device associated with the researcher or accessed by a remote device associated with the researcher. The apparatus may further receive the response to the user-generated request and cause the response to be communicated to the mobile device. In other examples, the apparatus may provide the researcher information for routing the response to the mobile device directly.

The apparatus may further identify context associated with the mobile device; for example, geographical information, user profile information, and the like. The response may be based, at least in part, on the identified context. Further, the apparatus may identify the user and determine various associated user accounts, such as email accounts, Personal Information Management (PIM) accounts (e.g., contacts, calendar, notes, etc.), media object storage accounts, and so on, such that the researcher may access the associated user accounts for formulating the response.

According to another aspect of the present invention, a method for asynchronous searching between a user and a researcher is provided. In one example, the method comprises the acts of receiving a user-generated request from a mobile device, causing communication of the received request to a researcher, and causing communication of a response to the request to the mobile device. The method may further include routing and storing the received request in a queue (locally or remotely) for access by the researcher. Further, the identity of the user may be determined and used to map the user to user accounts, such as email accounts, PIM accounts, media object storage accounts, and so on, wherein the researcher may access the user associated accounts for formulating the response.

According to another aspect of the present invention, a computer program product comprising computer-executable program code for facilitating asynchronous searching between a user and a researcher is provided. In one example, the product comprises program code for receiving a user-generated request from a mobile device, causing communication of the received request to a researcher, and causing communication of a response to the request to the mobile device. The computer program product may further comprise program code for storing the received request in a queue for access by the researcher. Additionally, the computer program product may include program code for identifying the user and associated user accounts, such as email accounts, PIM accounts, media object storage accounts, and so on, wherein the researcher may access the user associated accounts for formulating the response.

The various aspects and examples of the present inventions are better understood upon consideration of the detailed description below in conjunction with the accompanying drawings and claims.

### BRIEF DESCRIPTION OF THE DRAWINGS

FIG. 1 illustrates an exemplary environment in which some aspects and examples described herein may by used;

FIG. 2 schematically illustrates an exemplary flow of communication for an asynchronous response by a researcher to a user-generated request;

FIG. 3 illustrates an exemplary method for asynchronously responding to a user-generated request;

FIG. 4 illustrates an exemplary method for asynchronously responding to a user-generated request; and

FIG. 5 illustrates an exemplary computing system that may be employed to implement processing functionality for various aspects of the invention.

### DETAILED DESCRIPTION

The following description is presented to enable a person of ordinary skill in the art to make and use the inventions. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the inventions. Thus, the present inventions are not intended to be limited to the examples described herein and shown, but are to be accorded the scope consistent with the claims.

According to one aspect and example of the present invention, apparatus for an asynchronous research platform is provided in which a user may submit one or more requests for information via a mobile device. In one example the apparatus includes a server operable to receive a user-generated request from a mobile device, communicate the request to a researcher (i.e., a person) for formulating a response to the request, and communicate the response to the mobile device. Each received request is routed (or made available) to one or more researchers that attempt to obtain the information or content requested. Once the information is located, a response is sent back to the user with the requested information. The process operates asynchronously where, for example, a user's request is queued (remotely or locally with respect to the server) until a researcher (i.e., a person) is available to serve the request by obtaining the information requested. Because a researcher ultimately serves the request, the quality and relevancy of information obtained may be improved over automated systems that rely solely on computers to serve such requests.

The exemplary systems and methods described herein may be employed to provide research platforms for users to search and access various sources of information. For example, the platform may provide data useful for replacing or enhancing other research study methods, such as diary studies, beeper studies, and so on, however, various other applications and uses will be apparent. Further, the exemplary system and methods may provide useful feedback or rewards (e.g., experience relevant content deliver) to aid in conducting studies that desire user experience reporting.

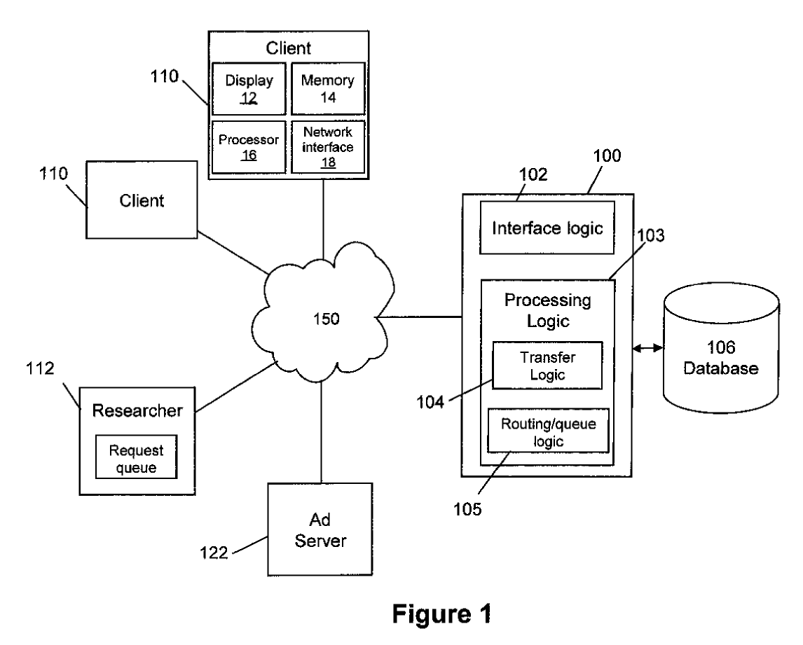

FIG. 1 illustrates an exemplary environment for certain aspects of an asynchronous research platform. In particular, FIG. 1 illustrates a client-server system in which one or more client devices 110 (e.g., mobile devices) communicate with one or more servers 100 via network 150. Client devices 110 may include various mobile devices such as a mobile telephone, PDA, smart phone, pager, walkie talkie, Wi-Fi device, pocket personal computer, integrated devices combining one or more of the preceding devices, or other mobile devices generally characterized as being suited for mobile and wireless applications and often, but not necessarily, less capable (in terms of processing power, memory, display capabilities, and the like) relative to conventional laptop or desktop computers. Client devices 110 typically include a processor 16 connected to an input device such as a keypad (not shown), a network interface 18, a memory 14, and a display 12. The memory 14 may include logic or software operable with the client device to perform some of the functions described herein.

Client devices 110 may be operable, for example, display a web browser or other user interface for accessing network 150 and communicating with server 100. Client devices 110 and server 100 may communicate, in part or in whole, via wireless or hardwired communications, such as Ethernet, IEEE 802.11b wireless, or the like. Additionally, communication between client devices 110 and server 100 may include various servers such as a mail server, mobile server, media object server, map server, and the like.

Researcher device 112, similar to client devices 110 may include various mobile devices as well as non-mobile computing devices such as personal computers, laptops, workstation computers, and the like. Additionally, researcher device 112 may communicate in any suitable fashion via network 150 with server 100 and/or client devices 110. It is also noted that although only one research device 112 is shown, in practice multiple researchers and researcher devices 112 are contemplated.

Server 100 comprises interface logic 102 (which may be included via a web server, for example) for interfacing with network 150 to receive user-generated requests from client devices 110. Interface logic 102 may be operable to receive any suitable communication such as SMS messages, text searches, media objects (e.g., voice or audio files containing requests as well as other images, videos, or audio files), and the like. To that end, server 100 and/or interface logic 102 may include http web server logic and may utilize various Web data interface techniques such as Common Gateway Interface (CGI) protocol and associated applications (or “scripts”), Java® “servlets”, i.e., Java® applications running on the Web server, or the like to present information and receive input from client devices 110.

Server 100 further includes processing logic 103 for processing requests and/or responses for presentation to users of client devices 110 as discussed in the examples herein. Processing logic 103 may include various components known in the art, e.g., a scripting engine (such as a PHP scripting engine), an aggregation engine, and the like. A scripting engine may include authentication logic, upload logic, metadata processing logic, permissions handling logic, and the like. The authentication logic may authenticate and identify a user making a request to server 100, which may be used to map the user to associated user information (e.g., to one or more user accounts) if any. Upload logic may be used to upload from the client to the server data conforming to any media format, e.g., still image (e.g., JPEG, TIFF), video (e.g., MPEG, AVI), or audio (e.g., MP3, OGG). The aggregation engine may include a statistics engine and a search engine.

Server 100 further comprises transfer logic 104 for processing one or more received requests from client devices 110. For example transfer logic 104 may comprise routing/queue logic 105 for routing a user-generated request to one or more researcher devices 112 and/or placing a user-generated request into a queue (e.g., located locally with server 100 or a queue associated with researcher device 112) for retrieval by one or more researcher device 112. Additionally, transfer logic 104 may further comprise logic for directing or communicating a received response (which may include a link to information), serviced by a researcher device 112, to a client device 110.

Server 100 may further comprise or be in communication with database 106 for storing data such as user information (e.g., user identifications) as well as data associated with a user (e.g., associated accounts such as an email account, PIM account, media object storage account, and the like). Server 100 may further store activity data associated with the received user-generated requests and/or responses with database 106. Database 106 and server 100 may further be included with a common backend or server network or remote with respect to each other.

FIG. 1 further illustrates an advertisement server 122, which may communicate with server 100, one or more client devices 110, one or more researcher devices 112, or combinations thereof. Advertisement server 122 may operate to associate advertisements with user-generated search requests and/or responses for transmission to a client device 110. For example, an advertisement may be associated with a response to the client devices 110 based on the query and/or the particular response to the query. In one example, the advertisement server 122 communicates with server 100 and transmits advertisement data thereto, for example, in response to a user-generated request received from client device 110. Server 100 may transmits the advertisement data with a response to client device 110. In other examples, the advertisement server may send the advertisement data directly to client device 110 based on information from server 100, client device 110, researcher device 112 or combinations thereof.

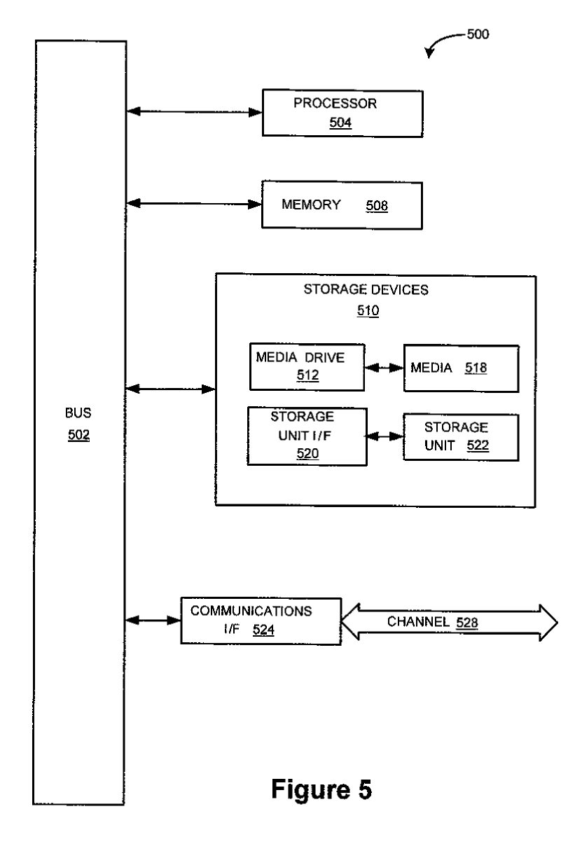

It should be noted that although the exemplary methods and systems described herein describe use of a separate server and database for performing various functions, other embodiments could be implemented by storing the software or programming that operates to cause the described functions on a single device or any combination of multiple devices as a matter of design choice so long as the functionality described herein is performed. Although not depicted in the figures, server 100 generally includes such art recognized components as are ordinarily found in server systems, including but not limited to processors, RAM, ROM, clocks, hardware drivers, associated storage, and the like (see, e.g., FIG. 5, discussed below). Further, the described functions and logic may be included in software, hardware, firmware, or combination thereof.

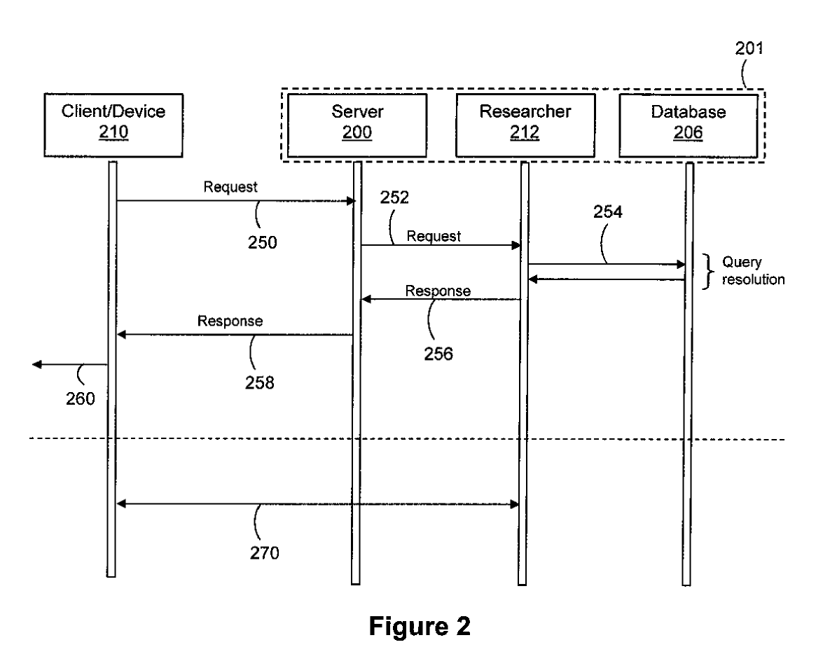

FIG. 2 illustrates an exemplary flow of communication between a client device 210, server 200, and researcher 212 to facilitate a user-generated request. In some examples, the client device 210 downloads a client side application for submitting requests and/or viewing responses to requests. In other examples, the requests and/or responses may be transmitted via various messaging services, such as commonly used SMS or the like. Further, client device 210 and/or the user thereof is initially mapped to the service provider network, e.g., to server 200, to associate information with the user identity such as user profile information, user accounts, and the like. The initial identification and mapping may be based on any suitable identification information such as device identification, phone number, login identification, or the like.

Initially, a user of client device 210 enters a user-generated request. The request may take various forms including user entered text, voice (e.g., a recorded audio file from the user), selections from a menu, and so on. Further, the request may be transmitted at 250 to the server 200 using any suitable communication method and service. In one example, request 250 comprises an SMS message; however, other communication and message formats such as second and third generation data communications of EMS (Enhanced Messaging Service), MMS (Multimedia Message Service), General Packet Radio Service (GPRS), or Enhanced Data rates for Global Evolution (EDGE) are contemplated. The message may be sent to an address (e.g., an http:// address) associated with server 200, wherein a suitable script (e.g., a PHP script) or application associated with server performs functions on the request (e.g., identifying a researcher, queuing and/or routing of the request).

In addition to receiving the request at 250, server 200 may further receive information associated with the identity of mobile device 210 (either concurrently with receiving the request or separate therefrom). For example, server 200 may receive a user identification or device identification which can be mapped to a user id and associated user information. Thus, server 200 may identify and determine various associated user accounts, such as email accounts, Personal Information Management (PIM) accounts (e.g., contacts, calendar, notes, etc.), media object storage accounts, and so on, such that researcher 212 may access the associated user accounts for formulating the response.

Additionally, in one example, server 200 attempts to collect and store information about the context of the query including, for example, location, time, nearby users, phone settings or the like.

Server 200 communicates either the request, a notification of the received request, or both to a researcher 212 at 252. In one example, requests are placed into a queue to be analyzed by one or more of the researchers. For example, the request itself may be queued either with a remote device, e.g., a computer or workstation associated with a researcher 212, for retrieval and resolution by researcher 212. In other examples, the request is queued locally with server 200 and a message or notification (e.g., by email and/or text message) is communicated to researcher 212 indicating that a request has been received, wherein the researcher may access the request via server 200. For example, server 200 may send an SMS or page to a researcher indicating a request has been received and queued. Researcher 212 may then access the request and perform query resolution at a suitable computing device. Depending on the particular communication method employed, the time from when a user submits a request to server 200 to when a researcher 212 is notified or receives the request may be less than one minute, and for some communication methods on the order of a few seconds or less.

Broadly speaking, researcher 212 reviews the user-generated request and performs query resolution. For example, researcher 212 accesses a database 206 to formulate a response to the query at 254. Database 206 may be local or remote to server 200 and/or researcher 212. In one example, the researcher may access one or more accounts associated with the user, e.g., email account, PIM account, photo/video storage accounts, and so on, to perform the query resolution. For example, a user may request a particular photo they have stored (e.g., “send me the latest picture of my son, Henry) or information from their contacts (e.g., “please send me Julia's phone number”). The researcher may access the appropriate accounts linked to the user and formulate the response. It should be noted and understood that researcher 212 may access multiple databases, both locally and remotely, to respond to a request; additionally, a researcher 212 may perform general web based searches for information.

Researcher 212 may communicate the response to server 200 at 256, which is in turn communicated to client device 210 at 258. In one example, the response is communicated to server 200 and server 200 creates an SMS message to mobile device 210 containing the response. The response 258 may comprise an SMS message with a link to information associated with the response, e.g., the information stored with server 200, researcher 212, database 206, or elsewhere. For example, the user may receive an SMS message containing a link directing the user to a webpage containing information associated with the response, which may include a media object such as an image, video file, audio file, etc., textual information such as directions, prices, reviews, or any other type of content request and capable of display with the user device.

In one example, the response may bypass server 200. For example, the researcher may receive information for responding directly to device 210 (e.g., when receiving request at 252). For example, an SMS message or the like responding to the request may be communicated to client device 210 directly as shown at 270.

In one example, the information requested is sent back to the user through the same communication format that the user sent the initial request. For example, if the request is received via SMS, the response is communicated to the user via SMS. In other examples, the response is sent based on the client device or network available for the client device. For example, if a user requests a high-resolution image of the Empire State Building while driving in New York City, one or more researchers may locate the requested content and send the content back to the requesting user. If the user has access to a high speed data network, the high-resolution picture may be sent; however, if a high speed data network is not available to the user device, a lower-resolution image or a link to the picture is transmitted to the user.

The response is displayed to the user at 260. For example, depending on the response, the display may include visually displaying text or image(s), as well as playing audio to the user. The response may be further stored with server 200 or database 206 for access by the user of client device 210 at a later time. The request and response may be stored together on a webpage associated with server 200 or with a database associated with a user account for later viewing by the user. In one example, each request and/or response is published online, e.g., with an online question and answer service, such as Yahoo! ® Answers. In such an example, the request may be removed from the answer service or marked as inactive as the user no longer desires the requested information.

In one example, the response to a user uses a different means of communication for responding than the means of communication for which the request was made. For example, the query may be done via http or a voice message, and the response via SMS and including a web link.

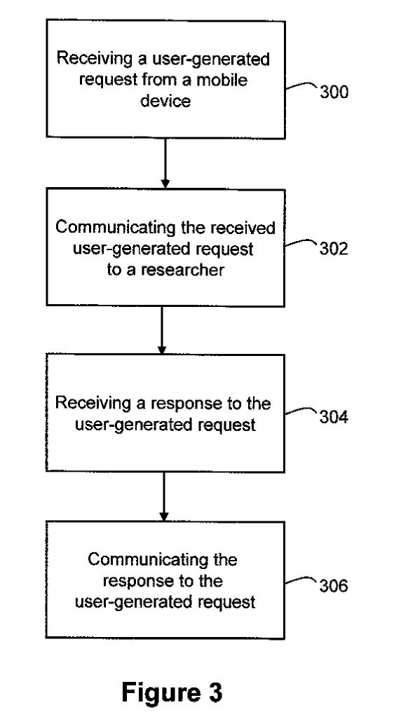

FIG. 3 illustrates an exemplary method for responding to a user-generated request in an asynchronous manner. Initially, a user-generated request is received at 300 from a user device, e.g., a mobile device. As described, the request may be received in various data formats. In one example, the request is received as audio data associated with voice message spoken by a user; accordingly, the request may be communicated and received as an audio file.

The method further includes, at 302, communicating at least a portion of the received user-generated request to a researcher, notifying a researcher that a request has been received, or both. For example, the received request may be made available to a researcher by communicating the request to a device associated with the researcher or notifying the researcher that a request has been received. To this end, a server may route the request to one or more researches and/or queue the request for the one or more researchers. Further, a server or other apparatus may identify a researcher to receive the request randomly or based on a match of the information associated with the request and/or user to the researches, for example.

The method further includes receiving a response to the user-generated request at 304. The response may include a link to further information such as textual information, media objects, and the like. The response is further communicated to the mobile device at 306, where the user may then access the response, which may include the requested information or link the user to further information stored remote to the user device, e.g., a website located remotely.

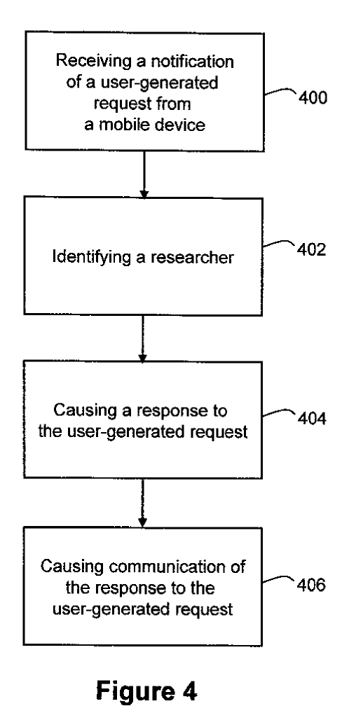

FIG. 4 illustrates another exemplary method for responding to a user-generated request in an asynchronous manner. In this example, the method includes receiving an indication of a request from a mobile device at 400. For example, a server (e.g., server 100 or 200) receives a notification or alert that a user of a mobile device submitted a request or has a request to submit. The method further includes identifying a researcher at 402 for receiving the user-generated request. In this particular example, the apparatus that receives the notification and identifies the researcher for formulating a response, does not necessarily receive the user-generated request; rather, the device may merely identify a research for the user-generated request to be communicated with.

The method further includes causing the generation of a response to the request at 404 and communicating the response to the user device at 406. In particular, the researcher that receives the request formulates a response (e.g., by accessing remote or local databases) and communicates the response to the user device (e.g., via an SMS message or the like). The response, similar to the request, need not be received by the server which received the initial notification at 402.

While aspects of the invention, including the above described methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

FIG. 5 illustrates an exemplary computing system 500 that may be employed to implement processing functionality for various aspects of the invention (e.g., as a server device or system, mobile user device, researcher device, memory device, and so on). Those skilled in the relevant art will also recognize how to implement the invention using other computer systems or architectures. Computing system 500 may represent, for example, a desktop, mainframe, server, memory device, mobile client device, or any other type of special or general purpose computing device as may be desirable or appropriate for a given application or environment. Computing system 500 can include one or more processors, such as a processor 504. Processor 504 can be implemented using a general or special purpose processing engine such as, for example, a microprocessor, microcontroller or other control logic. In this example, processor 504 is connected to a bus 502 or other communication medium.

Computing system 500 can also include a main memory 508, for example random access memory (RAM) or other dynamic memory, for storing information and instructions to be executed by processor 504. Main memory 508 also may be used for storing temporary variables or other intermediate information during execution of instructions to be executed by processor 504. Computing system 500 may likewise include a read only memory (“ROM”) or other static storage device coupled to bus 502 for storing static information and instructions for processor 504.

The computing system 500 may also include information storage mechanism 510, which may include, for example, a media drive 512 and a removable storage interface 520. The media drive 512 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 518 may include, for example, a hard disk, floppy disk, magnetic tape, optical disk, CD or DVD, or other fixed or removable medium that is read by and written to by media drive 514. As these examples illustrate, the storage media 518 may include a computer-readable storage medium having stored therein particular computer software or data.

In alternative embodiments, information storage mechanism 510 may include other similar instrumentalities for allowing computer programs or other instructions or data to be loaded into computing system 500. Such instrumentalities may include, for example, a removable storage unit 522 and an interface 520, such as a program cartridge and cartridge interface, a removable memory (for example, a flash memory or other removable memory module) and memory slot, and other removable storage units 522 and interfaces 520 that allow software and data to be transferred from the removable storage unit 518 to computing system 500.

Computing system 500 can also include a communications interface 524. Communications interface 524 can be used to allow software and data to be transferred between computing system 500 and external devices. Examples of communications interface 524 can include a modem, a network interface (such as an Ethernet or other NIC card), a communications port (such as for example, a USB port), a PCMCIA slot and card, etc. Software and data transferred via communications interface 524 are in the form of signals which can be electronic, electromagnetic, optical, or other signals capable of being received by communications interface 524. These signals are provided to communications interface 524 via a channel 528. This channel 528 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 508, storage device 518, storage unit 522, or signal(s) on channel 528. These and other forms of computer-readable media may be involved in providing one or more sequences of one or more instructions to processor 504 for execution. Such instructions, generally referred to as “computer program code” (which may be grouped in the form of computer programs or other groupings), when executed, enable the computing system 500 to perform features or functions of embodiments of the present invention.

In an embodiment where the elements are implemented using software, the software may be stored in a computer-readable medium and loaded into computing system 500 using, for example, removable storage drive 514, drive 512 or communications interface 524. The control logic (in this example, software instructions or computer program code), when executed by the processor 504, causes the processor 504 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

What is claimed is:

1. Apparatus for facilitating asynchronous searching between a user and a researcher, the apparatus comprising:
logic for receiving a user-generated request from a mobile device;
logic for causing communication of at least a portion of the request to a researcher for generating a response to the request; and
logic for causing communication of the response to the mobile device.

2. The apparatus of claim 1, wherein the request is communicated to a remote device associated with the researcher.

3. The apparatus of claim 1, further comprising logic for receiving the response to the user-generated request and causing the response to be communicated to the mobile device.

4. The apparatus of claim 1, further comprising logic for communicating to the researcher information for routing the response to the mobile device.

5. The apparatus of claim 1, wherein the user-generated request comprises one of a text message, a voice recording, a video, or an image.

6. The apparatus of claim 1, wherein the response comprises one of a text message, a voice recording, or an image.

7. The apparatus of claim 1, wherein the response comprises a link to information.

8. The apparatus of claim 1, further comprising logic for identifying context associated with the mobile device, wherein the response is based on the identified context.

9. The apparatus of claim 1, further comprising logic for identifying the user.

10. The apparatus of claim 1, wherein the response includes or links to information from a user account.

11. The apparatus of claim 1, wherein the researcher is provided access to accounts associated with the user for generating the response.

12. The apparatus of claim 1, further comprising logic for storing information associated with the user-generated requests and response.

13. Apparatus for facilitating asynchronous searching between a user and a researcher, the apparatus comprising:
logic for receiving information associated with a user-generated request from a mobile device; and
logic for causing communication of an indication to a researcher of the user-generate request for generating a response to the request.

14. The apparatus of claim 13, further comprising logic for communicating an identity of the user to the researcher.

15. The apparatus of claim 13, further comprising logic for causing communication of the request to the researcher.

16. The apparatus of claim 13, further comprising logic for causing storage of the request in a queue accessible by the researcher.

17. A method for asynchronous searching between a user and a researcher, the method comprising the acts of:
receiving a user-generated request from a mobile device;
causing communication of the received request to a researcher; and
causing communication of a response to the request to the mobile device.

18. The method of claim 17, further comprising storing the received request in a queue for access by the researcher.

19. The method of claim 17, wherein the response comprises one of a text message, voice recording, video, image, or a link to a webpage.

20. The method of claim 17, wherein the response comprises a text message.

21. The method of claim 17, wherein the response comprises a link to a webpage.

22. The method of claim 17, further comprising identifying context associated with the mobile device, wherein the response is based on the identified context.

23. The method of claim 17, further comprising accessing one or more accounts associated with the user for generating the response.

24. A computer program product comprising computer-executable program code for facilitating asynchronous searching between a user and a researcher, the product comprising program code for:
receiving a user-generated request from a mobile device;
causing communication of the received request to a researcher; and
causing communication of a response to the request to the mobile device.

25. The computer program product of claim 24, further comprising program code for storing the received request in a queue for access by the researcher.

26. The computer program product of claim 24, wherein the response comprises a text message.

27. The computer program product of claim 24, wherein the response comprises a link to a webpage.

28. The computer program product of claim 24, further comprising program code for identifying context associated with the mobile device, wherein the response is based on the identified context.

29. The computer program product of claim 24, further comprising program code for accessing one or more accounts associated with the user for generating the response
